(19) United States
(12) Patent Application Publication
(10) Pub. No.: US 2009/0159310 A1
(43) Pub. Date: Jun. 25, 2009

(54) Photonic-Crystal Transparent-Conductor Assembly

(76) Inventors: Nicholas Francis Borrelli, Elmira, NY (US); Karl William Koch, III, Elmira, NY (US)

Correspondence Address: CORNING INCORPORATED, SP-TI-3-1, CORNING, NY, 14831, US

(21) Appl. No.: 12/273,685

(22) Filed: Nov. 19, 2008

Related U.S. Application Data
(60) Provisional application No. 61/008,328, filed on Dec. 19, 2007.

(51) Int. Cl. H01B 5/00

(52) U.S. Cl. 174/126.1

(57) ABSTRACT

A photonic-crystal (PC)-based transparent-conductor assembly is disclosed, wherein the assembly includes a photonic-crystal cloaking element (PCCE) that surrounds at least one opaque conducting element. The PCCE has a refractive index distribution designed to “cloak” the at least one conductor contained therein from light incident upon the PCCE within a select wavelength range. The cloaking effect from the PCCE leaves light incident upon the assembly traveling in its original path as if undisturbed, thereby effectively rendering the conductor, as well as the PCCE, “transparent.” This allows for the formation of a transparent conductor from an otherwise opaque conductor. One or more such PC transparent-conductor assemblies can be configured so that a pattern of otherwise opaque conducting elements can form a transparent electrode array useful for a variety of electric-field-driven optical devices such as optical displays.

This application claims the benefit of priority under 35 U.S.C. §119 (e) of U.S. Provisional Application Ser. No. 61/008,328 filed on Dec. 19, 2007.

### FIELD OF THE INVENTION

The present invention relates generally to conductors, and in particular to transparent conductors used as electrodes in microelectronic devices such as displays.

### BACKGROUND OF THE INVENTION

Materials that are transparent to visible light and that also conduct electricity are useful in applications where electricity needs to be delivered to electrical components, but where the conductor must not optically obstruct the electrical components. Such transparent conductors have found particular use as electrodes for various types of microelectronic devices, and in particular displays, such as liquid crystal, plasma, and electroluminescent displays, as well as see-through displays such as “heads-up” displays used, for example, in aircraft and virtual-reality systems. Electrode transparency is required in most thin, high-resolution displays because space limitations require that at least some of the electrodes cover at least a portion of the particular light-emitting devices used as the display pixels. To the extent such electrodes are not perfectly optically transmitting (transparent), they tend to reduce the overall brightness and quality of the displayed image.

Typical conducting films used as electrodes are tin-doped indium oxide, fluorine-doped tin oxide, or doped zinc oxide. The transparent conducting films made from these metal oxides are usually formed on glass or ceramic substrates. Known methods of forming transparent conducting films include chemical vapor deposition (CVD) methods (e.g., plasma CVD methods and light CVD methods), physical vapor deposition (PVD) methods (e.g., vacuum evaporation methods, ion plating methods and sputtering methods), and various coating methods.

All transparent conducting films have about the same optical transmittance and about the same resistivity for a given film thickness. Of all transparent conducting films, indium tin oxide (ITO) films have the lowest resistivity, e.g., ˜10⁻⁴ Ohm-cm for a ˜120 nm thick film. However, the resistance of transparent conducting films can limit the size of a device, such as a display, that calls for extended lengths of conducting film. The size limit is due to the voltage drop over the length of the conductor, which is calculated from the surface resistance of the conducting film.

For many applications, including displays, it would be beneficial to have transparent conductors with higher conductivity (lower resistivity) and greater transparency than is presently available with transparent conducting films. Ideally, it would be beneficial to have a transparent conductor with the high conductivity of otherwise opaque conductors such as copper, gold, silver, platinum and the like.

### SUMMARY OF THE INVENTION

A first aspect of the invention is a photonic-crystal (PC) conductor assembly that includes a photonic-crystal cloaking element (PCCE) configured to have a cloaked interior region, and at least one opaque conductor arranged in the interior region so that the at least one conductor is rendered transparent to light of a select wavelength band incident upon the PCCE.

One embodiment of the present invention is PC transparent-conductor assembly. The assembly includes a photonic crystal element having an elongate, radially symmetric dielectric annular body with an outer surface having an outer radius b, and an inner surface having inner radius a. The inner surface defines an interior region. The photonic crystal body has a plurality of cylindrical holes formed therein and configured, in combination with the inner and outer radii, to provide the photonic crystal body with a permittivity ε and a permeability μ that satisfies the following cloaking relationships over a select wavelength range:

$${ɛ}_{r} = {μ}_{r} = \frac{r - a}{r} , \\ {ɛ}_{θ} = {μ}_{θ} = \frac{r}{r - a} , \\ {ɛ}_{z} = {μ}_{z} = {( \frac{b}{b - a} )}^{2} \frac{r - a}{r}$$

wherein r is a radial direction, z is an axial direction and θ is an angular direction. The assembly also includes at least one conducting element being substantially opaque over at least a portion of the select wavelength range. The conducing element is arranged in the interior region of the photonic crystal body so that light within the select wavelength range that is incident upon the photonic crystal body at one portion of the outer surface at an original trajectory is trapped in the photonic crystal body and exits the photonic crystal body at another outer surface portion without passing through the at least one conductor and with its original trajectory. This has the effect of rendering the conductor transparent.

Another aspect of the present invention is a method of forming a transparent conductor from an otherwise opaque conductor. The method includes forming a PC element to have a refractive index profile that results in a cloaked interior region. The method also includes arranging at least one opaque conductor in the interior region so that the at least one conductor is rendered transparent to light of a select wavelength band incident upon the photonic crystal. An optional embodiment of the method is to arrange a number of such PC elements side by side with conductors contained therein to create an array of (effectively) transparent conducting elements.

It is to be understood that both the foregoing general description and the following detailed description present example embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate the various exemplary embodiments of the invention and together with the description serve to explain the principles and operations of the invention.

### BRIEF DESCRIPTION OF THE DRAWINGS

FIG. 1A is side view of an example embodiment of a photonic crystal cloaking element (PCCE) used in the PC transparent-conductor assembly of the present invention;

FIG. 1B is a perspective close-up view of a section of the PCCE of FIG. 1;

FIG. 2 is a cross-sectional view of the PCCE of FIG. 1 and FIG. 2;

FIG. 3 is a plot of the permittivity ε vs. the (normalized) radial coordinate [r/a] for the cloaking conditions required for the PCCE as set forth in Equations (5A-5C);

FIG. 4 is a close-up view of the PCCE illustrating an example arrangement of cylindrical holes formed in the PCCE that creates the requisite cloaking conditions;

FIG. 5A is a plan view of an example PCCE illustrating the hole pitch dimension Λ and hole radius dimension ρ;

FIG. 5B is a perspective diagram of the example PCCE body of FIG. 5A, showing in phantom one of the cylindrical holes that extends the length of the PCCE;

FIG. 6A-FIG. 6D are plots of the effective refractive index n_{eff} as a function of the normalized wavelength (λ/Λ) for the eight lowest bands (modes) of the PCCE of FIG. 5A and FIG. 5B for normalized hole sizes of (ρ/Λ)=45, (ρ/Λ)=40, (ρ/Λ)=30, and (ρ/Λ)=20, respectively.

FIG. 7A plots the calculated permittivity ε vs. the normalized hole size (ρ/Λ) for the PCCE of FIG. 5A and FIG. 5B;

FIG. 7B plots the permittivity ε_{ρ} as a function of normalized radius (r/a) for b=1.33a for the annular PCCE shown in FIG. 1A, FIG. 1B and FIG. 2;

FIG. 8A is a side schematic view of an example embodiment of the PC transparent-conductor assembly of the present invention;

FIG. 8B is a perspective view of a section of the PC transparent-conductor assembly of FIG. 8A;

FIG. 9A is a cross-sectional view of the PC transparent-conductor assembly of FIG. 8A and FIG. 8B, illustrating an example embodiment wherein the conductor is in the form of a ribbon that includes three conducting wires;

FIG. 9B is a cross-sectional view similar to that of FIG. 9A, illustrating an example embodiment of the PC transparent-conductor assembly wherein the conductor is a single wire;

FIG. 10 is a schematic diagram of a display that shows a close-up view of the array of pixels and electrodes that make up the display;

FIG. 11A plots the intensity field surrounding adjacent PC transparent-conductor assemblies for plan-wave light traveling from right to left, illustrating how each assembly cloaks the conductor contained therein so as to create the effect of transparency for an array of PC transparent-conductor assemblies;

FIG. 11B is the same plot as FIG. 11A but for plane-wave light traveling at a 45-degree angle, illustrating how the transparency effect works for light traveling in different directions, and thus by implication for light traveling in any direction;

FIG. 12 is a schematic diagram of a section of an array of PC transparent-conductor assemblies that can serve, for example, as a transparent electrode array;

FIG. 13A is a schematic cross-sectional view of two adjacent PC transparent-conductor assemblies, illustrating an example embodiment wherein the conductors in adjacent assemblies are arranged as close together as possible; and

FIG. 13B is a schematic diagram similar to that of FIG. 13A, illustrating an example embodiment wherein the conductors in the adjacent assemblies are arranged as far apart as possible.

### DETAILED DESCRIPTION OF THE INVENTION

Reference is now made in detail to the present preferred embodiments of the invention, examples of which are illustrated in the accompanying drawings. Whenever possible, like or similar reference numerals are used throughout the drawings to refer to like or similar parts. Various modifications and alterations may be made to the following examples within the scope of the present invention, and aspects of the different examples may be mixed in different ways to achieve yet further examples. Accordingly, the true scope of the invention is to be understood from the entirety of the present disclosure, in view of but not limited to the embodiments described herein.

The present invention is directed to a photonic-crystal (PC)-based conductor assembly (“PC transparent-conductor assembly”) that includes a photonic-crystal cloaking element (“PCCE”) that surrounds at least one opaque conducting element. The PCCE has a refractive index distribution that “cloaks” the at least one conductor contained therein, effectively rendering it “transparent” over a select wavelength band. This allows for the formation of a “transparent conductor” from an otherwise opaque conductor. One or more such PC transparent-conductor assemblies can be configured in a manner such that a pattern of otherwise opaque conducting elements can be rendered transparent to provide an array of transparent electrodes for a variety of electric-field-driven optical devices.

The term “transparent” as the term is used herein to describe the otherwise opaque conductor means that the PCCE surrounding the conductor creates the optical effect of transparency by virtue of its refractive index distribution. That is to say, light that is incident the PC transparent-conductor assembly is caused by the PCCE to bend around the conductor in a manner that maintains the original path of the light when the light exits the PCCE. It thus appears to an observer that the light did not encounter any object, so that neither the conductor nor the PCCE are actually seen by the observer. Thus, not only is the conductor within the PCCE cloaked, but the PCCE that creates the cloaking effect is also cloaked because it too remains invisible to the observer.

### Theoretical Basis for Cloaking

The theoretical basis for cloaking is described, for example, in the article by Pendry et al., “Controlling electromagnetic fields,” Science, vol. 312, pp. 1780-1782, 23 June 2006, and in the article by Shurig et al., “Metamaterial electromagnetic cloak at microwave frequencies,” Science, vol. 314, pp. 977-978, 10 Nov. 2006, which articles are both incorporated by reference herein. It should be noted here that the basic relationship between the refractive index n, the electric permittivity (“permittivity”) ε and the magnetic permeability μ (“permeability”) is given by Maxwell's formula n=(εμ)^{1/2}.

The approach in the Pendry article starts with the principle that light also does not travel in straight lines in non-Euclidean metric spaces. The shortest distance between two points, and therefore the path of a light ray, is defined through the variational “shortest time” condition. For a 2-D metric space, this takes the form of Eq. (1), where g₁₁ and g₂₂ are elements of the metric tensor of the space:

$$δ = {\int }_{ }^{ } n ( {x}_{1} , {x}_{2} ) \sqrt{{g}_{11} + {{g}_{22} ( \frac{d {x}_{2}}{d {x}_{1}} )}^{2}} d {x}_{1} \qquad Eq . ( 1 )$$

The approach involves defining a transformation to such a space that would produce cloaking (have light bend around an object and continue on its original path), but then to reduce it to a flat space (whose coordinates are denoted by primes). The transformation is given by:

ds²=dx′₁²+dx′₂² Eq. (2)

The following transformation then maps the interior of a circle to an annulus:

$${r}^{′} = \frac{b - a}{b} r + a \qquad Eq . ( 3 )$$

where a and b are the inner and outer radii of the annulus.

One must now redefine the “material” constitutive properties—namely, the dielectric tensor—in order to obtain the behavior of light as if it were in a Cartesian flat space. One defines a material world where the dielectric functions (as well as all material parameters) are not constant but vary in space. One can explicitly obtain the relationship of the dielectric tensor ε′ᵢⱼ that determines the pattern that is to be constructed to provide the cloak:

$${ɛ}_{ij}^{′} = \frac{b}{b - a} [ {δ}_{ij} - \frac{2 {ar}^{′} - {a}^{2}}{{r}^{′4}} {x}_{i}^{′} {x}_{j}^{′} ] \qquad Eq . ( 4 )$$

Because ε′ᵢⱼ is a tensor, it has directional properties that make it challenging to form a corresponding physical structure. For simple cases, like specific polarization states of the incident light, (e.g., TE or TM), construction of the corresponding index profile is within experimental capabilities for the microwave regime. In the visible, however, varying the permittivity in the manner required by Eq. (4) is very difficult. However, considering only TM light flips the roles of (magnetic) permeability μ and the (dielectric constant) permittivity ε, enabling a structure with a constant permeability μ. The radial variation of the structure now occurs in the radial component of permittivity, namely εᵣ, which makes the formation of a visible-wavelength cloaking structure more easily achievable. For example, a refractive index structure for visible-wavelength light includes annular segments of thin metal wires oriented radially from the structure's center. The geometry of the wire produces the necessary anisotropy of the material response, while the radial configuration produces the required variation of εᵣ with radius.

The various theoretical approaches for creating a cloaking structure have a number of serious shortcomings with respect to the practicality of the implementation and the availability of materials that can form the requisite structure to exhibit the required cloaking behavior. Implementation issues have to do with the scale of the structure relative to the wavelength of light, while the material-related issues have to do with the ability to produce materials with the required refractive index profile. For example, depending on the specific approach used, some index profiles require a large positive refractive index while others might require a negative refractive index. This, when coupled with the required pattern of the index profile to achieve cloaking in more than one direction, the fabrication of the requisite optical structure remains quite daunting.

### Photonic Crystals

A photonic crystal is a dielectric structure having a periodic variation in dielectric constant ε. The periodic structure may be 1-, 2- or 3-dimensional. The photonic crystal allows passage of certain light wavelengths and prevents passage of certain other light wavelengths. Thus, the photonic crystals are said to have “allowed light wavelength bands” and a “band gap” that define the wavelength bands that are excluded from the crystal.

Light having a wavelength in the band gap may not pass through the photonic crystal. However, light having a wavelength in bands above and below the band gap may propagate through the crystal. A photonic crystal exhibits a set of band gaps, which are analogous to the solutions of the Bragg scattering equation. The band gaps are determined by the pattern and period of the variation in dielectric constant. Thus, the periodic array that forms the variation in dielectric constant acts as a Bragg scatterer of light of certain wavelengths, in analogy with the Bragg scattering of x-ray wavelengths by atoms in a lattice. Note that the effective refractive index n_{eff} of a mode is another way of expressing the propagation constant k(z) through the simple expression k(z)=(2π/λ)n_{eff}.

Methods of fabricating photonic crystals include, for example, the methods disclosed in U.S. Pat. No. 6,925,840, entitled “Method of making a photonic crystal preform,” U.S. Pat. No. 6,496,632, entitled “Method of fabricating photonic structures,” U.S. Pat. No. 6,444,133, entitled “Method of making photonic band gap fibers,” U.S. Pat. No. 6,260,388, entitled “Method of fabricating photonic glass structures by extruding, sintering and drawing,” and U.S. Pat. No. 6,243,522, entitled “Photonic crystal fiber,” which patents are assigned to Corning, Inc. (and which are referred to hereinbelow as “the Corning Patents”), and which are all incorporated by reference herein.

### PCCE for the PC Transparent-Conductor Assembly

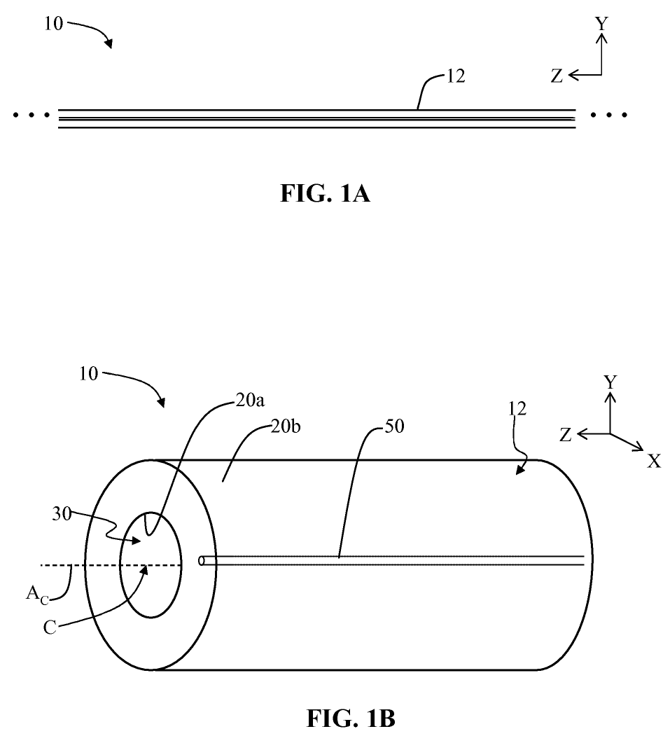

FIG. 1A is side view of photonic-crystal cloaking element (PCCE) 10, and FIG. 1B is a schematic perspective view of an example embodiment of a section of the PCCE of FIG. 1A. PCCE 10 is used to form the PC transparent-conductor assembly of the present invention as described in greater detail below. X-Y-Z Cartesian coordinates are provided for reference.

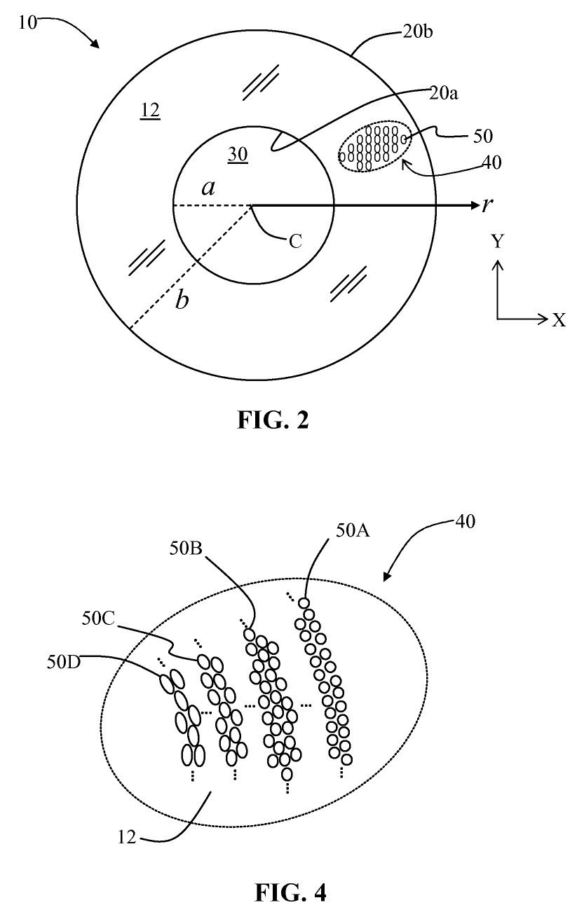

FIG. 2 is a cross-sectional view of PCCE 10 of FIGS. 1A and 1B. PCCE 10 includes an annular photonic crystal body (“photonic crystal”) 12 having a longitudinal central axis A_{C} coincident with a center C, an inner surface 20a at a radius a from the center, and an outer surface 20b at a radius b from the center. Inner surface 20a defines an interior region 30. The radial coordinate r and the X-Y Cartesian coordinates are also shown for the sake of reference. A close-up view of the structure of photonic crystal 12 is shown in a section 40 and is discussed in greater detail below.

Equation (4) above sets forth the general requirements for the permittivity ε for PCCE 10 to have cloaking capability, and in particular specifies the variation of the permittivity ε as a function of the radial coordinate r. It is useful to normalize the radial coordinate r to inner radius a, and to express the outer radius b in terms of inner radius a, such as b=4a/3.

From Equation (4), the equations describing the variation of the permittivity ε and permeability μ as a function of radius r are as follows:

$${ɛ}_{r} = {μ}_{r} = \frac{r - a}{r} , \\ {ɛ}_{θ} = {μ}_{θ} = \frac{r}{r - a} , \\ {ɛ}_{z} = {μ}_{z} = {( \frac{b}{b - a} )}^{2} \frac{r - a}{r} . \qquad Eqs . ( 5 A \text{-} 5 C )$$

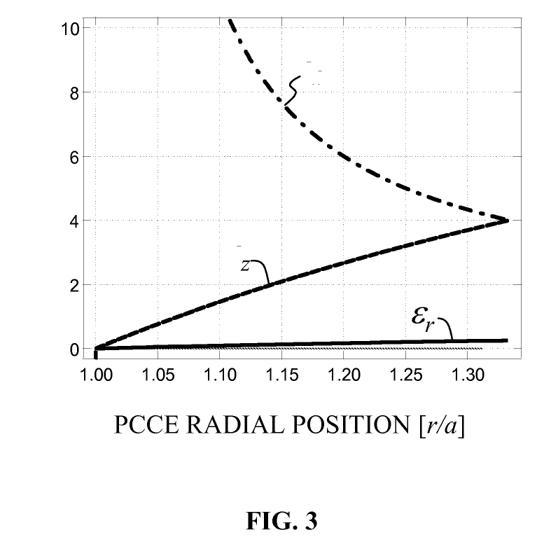

FIG. 3 plots the variation of the permittivity ε as a function of the normalized radial coordinate r/a based Equations (5A-5C), for b=4a/3.

If only the electric field polarized along the z-axis (i.e., the TE mode) is considered, then the material response is limited to the z-component of the permittivity ε_{z} and the r- and θ-components of the permeability εᵣ and ε_{θ}. To illustrate the trajectories of the waves within photonic crystal 12, one need only consider the products ε_{z}μᵣ and ε_{z}μ_{θ}. The radial dependence of these products allows one to consider the simplified set of relations:

$${μ}_{r} = {( \frac{r - a}{r} )}^{2} , \\ {μ}_{θ} = 1 , \\ {ɛ}_{z} = {( \frac{b}{b - a} )}^{2} . \qquad Eqs . ( 6 A \text{-} 6 C )$$

For the case where the magnetic field is polarized along the z-axis (TM, the products μ_{z}εᵣ and μ_{z}ε_{θ} are the only ones that need to be considered. The radial dependence of a simplified set of relations is:

$${ɛ}_{r} = {( \frac{r - a}{r} )}^{2} , \\ {ɛ}_{θ} = 1 , \\ {μ}_{z} = {( \frac{b}{b - a} )}^{2} . \qquad Eqs . ( 7 A \text{-} 7 C )$$

The only difference between these simplified relations and the original expressions set forth in Equations (5A-5C) is that there will be some reflectivity from photonic crystal 12 at outer surface 20b in the simplified case. The trajectories of the waves within the photonic crystals are the same.

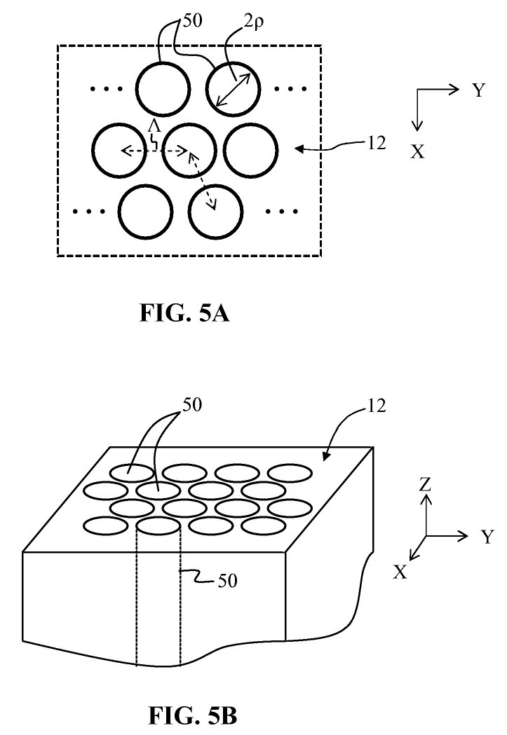

FIG. 4 is a close-up view of the structure of photonic crystal 12 for the aforementioned section 40 identified in FIG. 2. The photonic crystal structure is designed to satisfy the permittivity and permeability requirements set forth in Eqs. (5A-5C) so as to provide cloaking capability with respect to interior region 30. This is accomplished by selectively providing channels or “cylindrical holes” 50 in photonic crystal 12, wherein the holes extend longitudinally in the z-direction (i.e., parallel to central axis A_{C}). One such hole 50 is also shown in FIG. 2 by way of example. Holes 50 are used to vary the effective refractive index of a given mode through a change in hole pitch Λ, air-fill (ρ/Λ), and/or hole shape (aspect ratio), where ρ is the radius of the cylindrical holes (to distinguish from r, the general radial coordinate of PCCE as shown in FIG. 2).

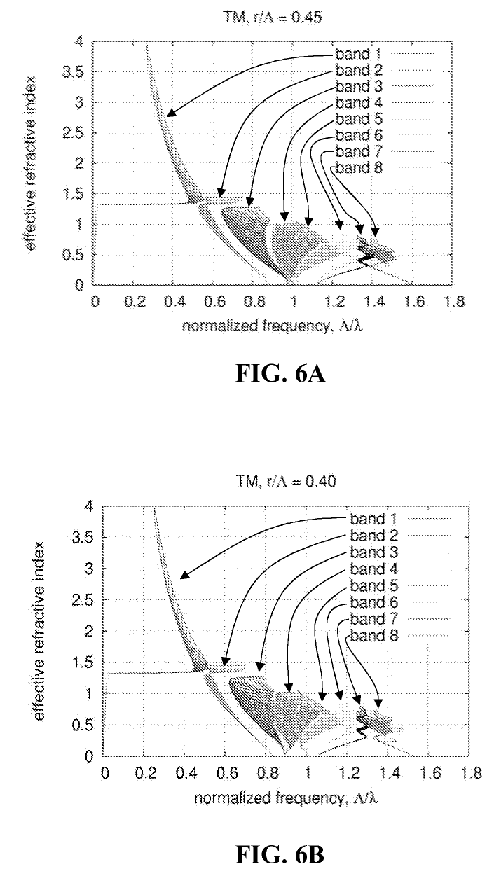

An example of how the effective refractive index n_{eff} can be made to vary with normalized wavelength (λ/Λ) as a function of the normalized hole size (ρ/Λ) is now discussed for the TM mode only. FIG. 5A is a plan view and FIG. 5B is a perspective view of an example embodiment of a photonic crystal 12 having a select arrangement of holes 50 formed therein.

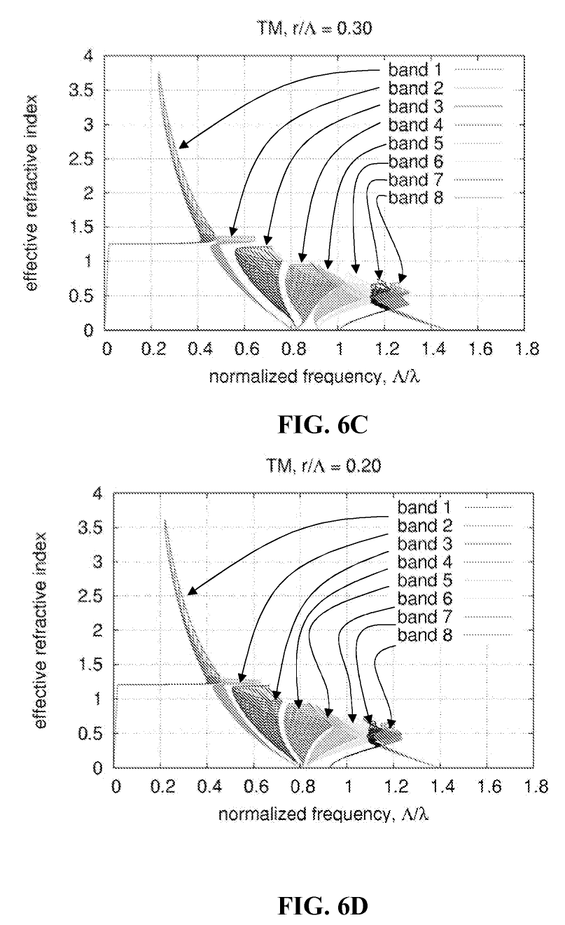

FIGS. 6A through 6D plot the effective refractive index n_{eff} as a function of the normalized wavelength (λ/Λ) for the eight lowest bands (modes) of the photonic crystal body shown in FIG. 5A and FIG. 5B for normalized hole sizes (ρ/Λ)=0.45, (ρ/Λ)=0.40 (ρ/Λ)=0.30 and (ρ/Λ)=0.20, respectively.

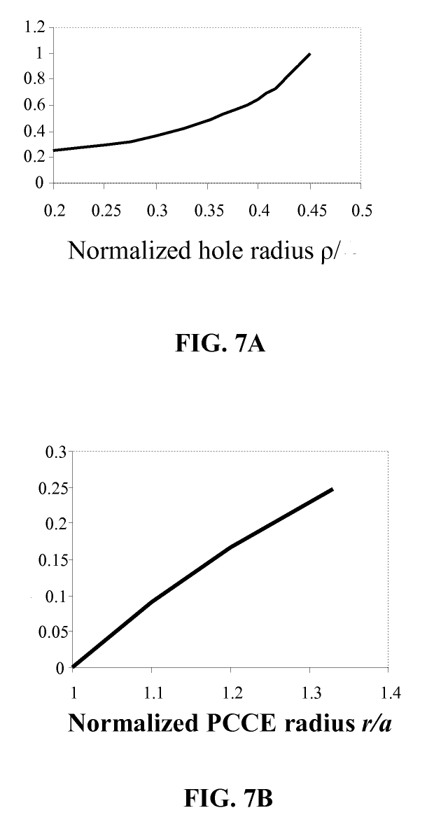

To ascertain the magnitude of the variation in permittivity ε that can be expected from changing the value of ρ/Λ, a given mode and a value for normalized wavelength λ/Λ is chosen. The permittivity εᵣ is then plotted against the normalized hole size (i.e., normalized hole radius) ρ/Λ. Such a plot is shown in FIG. 7A based on the values in FIGS. 6A-6D for band 2 and a normalized wavelength λ/Λ=0.6 for the photonic crystal 12 of FIG. 5A and FIG. 5B.

The data of FIGS. 6A-6D shows that the variation of the effective permittivity εᵣ caused by adjusting the normalized hole radius ρ/Λ allows one to create the desired profile for permittivity εᵣ. The cloaking permittivity profile εᵣ of Eq. (7A) is plotted in FIG. 7B for a=1, and b=1.33. The close-up view of FIG. 4, discussed above, illustrates an example of how cylindrical holes 50 can vary in size and pitch as a function of radius r in annular photonic crystal 12 in order to satisfy the cloaking condition of Eq. (7A). Such photonic crystal patterns are capable of being formed into optical fibers (e.g., via the methods described above in the cited Corning Patents), and in particular can be formed in large-area optical fibers that can accommodate at least one conductive element running down the length of the photonic crystal fiber, e.g., in a cylindrical hole (i.e., interior region 30) centered on central axis A_{C} (FIG. 1).

### PC Transparent-Conductor Assembly

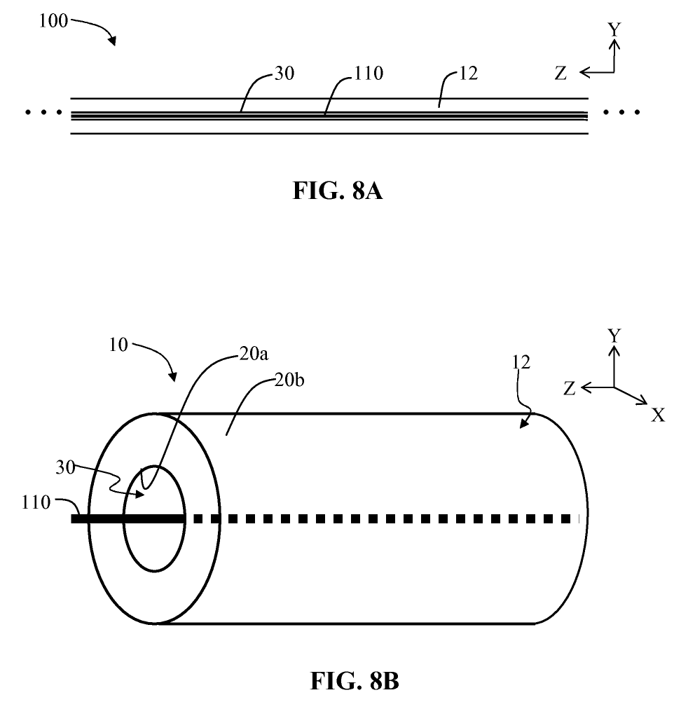

FIG. 8A is a schematic cut-away side view of an example embodiment of a photonic-crystal (PC) transparent-conductor assembly 100 according to the present invention that employs the above-described PCCE 10. FIG. 8B is a close-up perspective view of a section of PC transparent-conductor assembly of 100. Assembly 100 includes at least one conducting element (“conductor”) 110 residing in interior region 30 of PCCE 10.

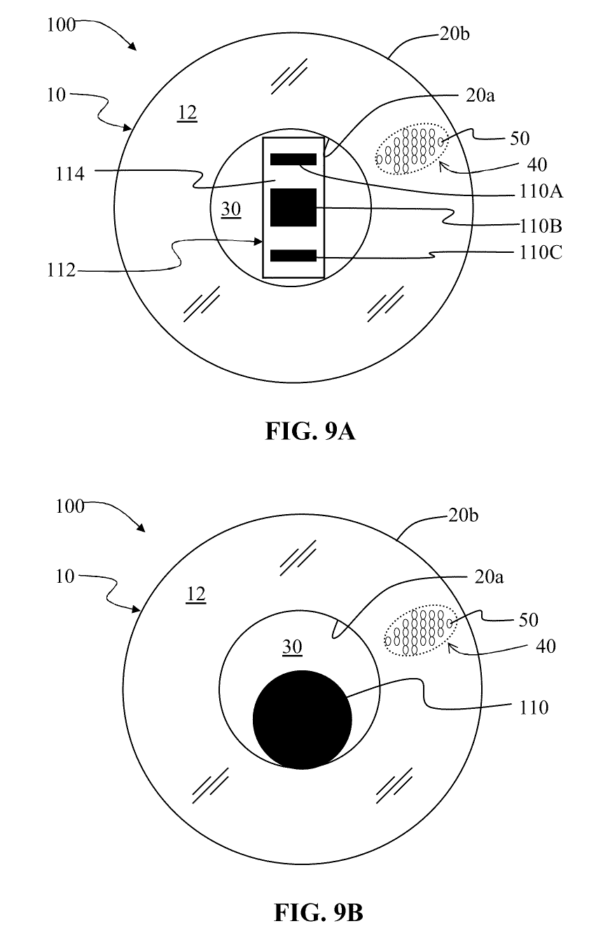

FIG. 9A is a cross-sectional view of PC transparent-conductor assembly 100 that illustrates an example embodiment that includes in region 30 of PCCE 10 three conductors 110A, 110B and 110C as part of a ribbon-type wire 112. Wire 112 includes a dielectric 114 that separates the three conductors. FIG. 9B is a cross-sectional view of assembly 100 similar to that of FIG. 9A, but that illustrates an example embodiment having a single conductor 110 (e.g., a wire). In an example embodiment, conductor 110 is fed into interior region 30 after PCCE 10 is formed. In another example embodiment, PCCE 10 is formed around conductor 110.

In an example embodiment, conductor 110 is formed from a highly conductive, non-transparent metal, and in a preferred embodiment, the metal is or includes copper, which has a very high conductivity of 10⁻⁶ Ohm.cm. In an example embodiment, conductor 110 includes at least one of gold, silver, aluminum, platinum, and copper.

Because PCCE 10 is designed to have cloaking capability, conductor 110 within interior region 30 is effectively rendered transparent. In fact, not only is conductor 110 rendered transparent, but PCCE is also transparent. Thus, PC transparent-conductor assembly as a whole is invisible over a select wavelength band, which in an example embodiment includes one or more visible wavelengths. This allows for conductor 110 to be inherently opaque while still remaining invisible due to the optical properties of PCCE 10. In a particular example embodiment, the select wavelength band includes the red, green and blue wavelengths (e.g., λ_{R}=630 nm, λ_{G}=532 nm and λ_{B}=465 nm, respectively) typically associated with color displays.

### Transparent Electrode Array

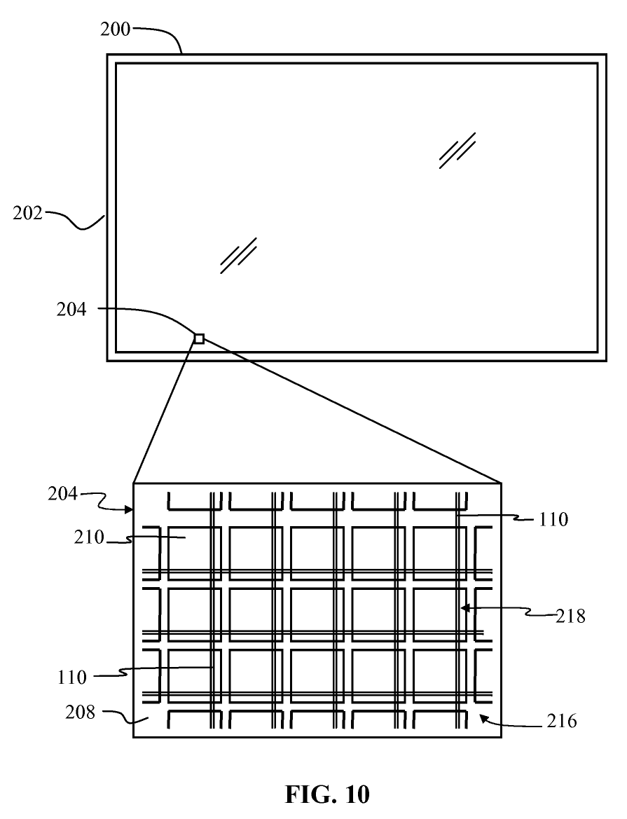

FIG. 10 is a schematic diagram of a display 200 that includes an active region 202 that generates the display image. FIG. 10 also includes a close-up view of a small section 204 of active region 202 that shows details of the active region. Active region 202 includes a substrate 208. Substrate 208 may include a number of layers both conductive and non-conductive (depending on the display type) configured to operably support the various elements of the display such as the pixels and the electrodes may be formed on different layers.

Substrate 208 operably supports an array of light-generating elements or pixels 210. Pixels 210 can be, for example, plasma-discharge cells for a plasma display, liquid-crystal pixels for a liquid crystal display (LCD), etc. Pixels 210 are electrically interconnected by an electrode array 216 made up of electrodes 218 (e.g., so-called “scan” and “sustain” electrodes). Electrode array 216 includes at least one electrode 218 formed by PC transparent-conductor assembly 100. Further in an example embodiment, the at least one electrode 218 formed by PC transparent-conductor assembly 100 is electrically connected to at least one pixel 210. Display 200 is the type wherein at least one of electrodes 218 needs to be transparent so that it does not obstruct light generated by pixels 210. In an example embodiment, at least a portion of electrode array 216 is formed by PC transparent-conductor assemblies 100 so that the corresponding portion of the array, or the entire array, is transparent.

An advantage of using PC transparent-conductor assemblies 100 for electrodes 218 is that the electrodes can have the high conductivity (i.e., low resistivity of ˜10⁻⁶ Ohm-cm) of non-transparent conductors such as copper, yet are made transparent by virtue of PCCE 10. This allows for a bright display that uses less power than displays that employ conventional transparent conductors whose lowest resistivity is about 10⁻⁴ Ohm-cm.

One possible issue in forming an array of transparent electrodes using PC transparent-conductor assemblies 100 relates to how close one can place the assemblies to each other without interfering with the cloaking effect provided by PCCEs 10. The proximity of conductors 110 also impacts the spatial uniformity of the applied field of the electrodes.

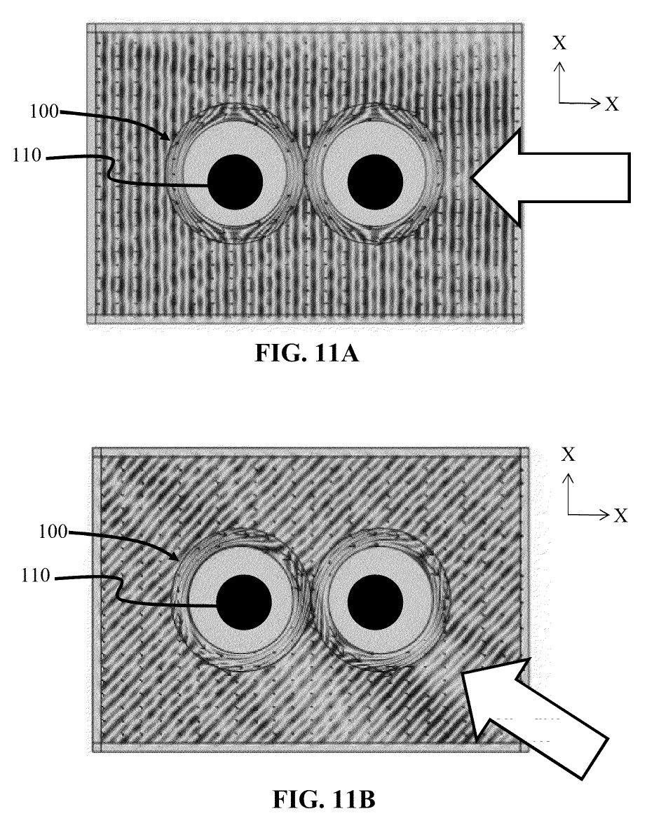

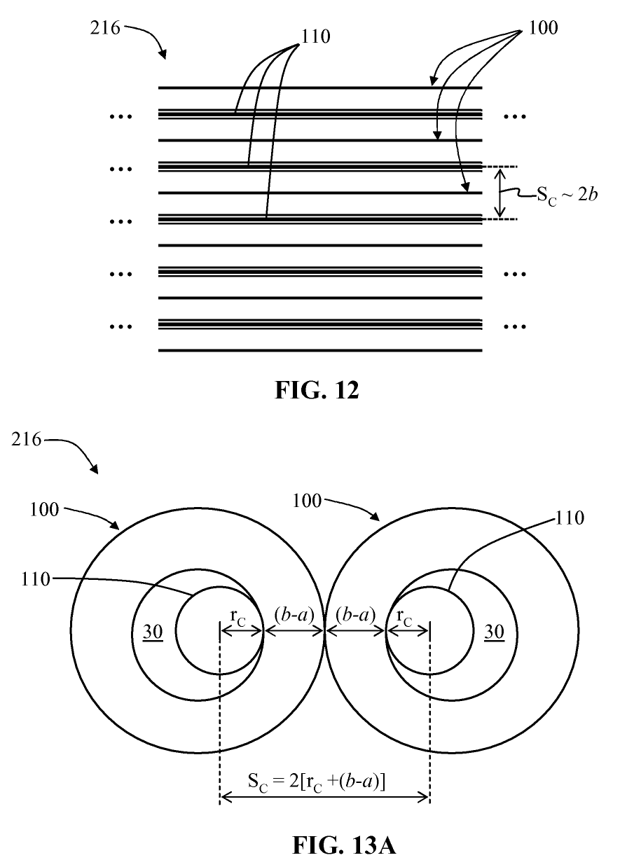

FIG. 11A and FIG. 11B are plots of the simulated light intensity for two closely spaced PC transparent-conductor assemblies 100. FIG. 11A is for light traveling along the X-direction, and FIG. 11B is for light traveling at 45 degrees to the X-axis. FIG. 11A and FIG. 11B show that even with adjacent PC transparent-conductor assemblies in contact, light is still routed around conductors 110 as if the conductor were not there, regardless of direction of light travel. The circular symmetry of PCCE 10 insures that if the cloaking member provides invisibility for a given incident plane wave, it will work identically for an arbitrary plane wave. And, since it works for an arbitrary plane wave, it can be shown to work for an arbitrary light (intensity) field by expanding the incident field in an angular spectrum of plane waves.

It should be noted that in the case of a pair of circularly symmetric PCCEs 10 as shown in FIG. 11A and FIG. 11B, the pair no longer possesses circular symmetry. Accordingly, it is not at all clear whether the pair of PCCEs will provide invisibility of conductors 110 for a plane wave with an arbitrary incident angle as accomplished by a single PCCE. However, the simulations plotted in FIGS. 11A and 11B show that invisibility is indeed maintained even for a pair of contacted PCCE members 10. This surprising property enables the formation of transparent conductor (electrode) arrays 216.

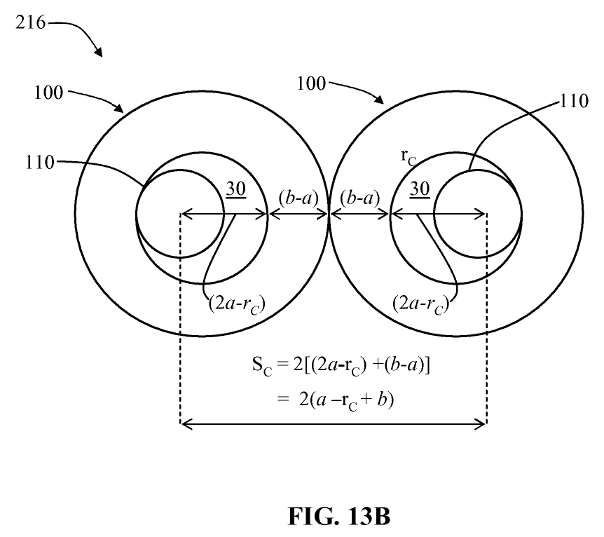

FIG. 13A is a schematic diagram of a section of a transparent electrode array 216 that includes two PC transparent-conductor assemblies 110 arranged side-by-side, such as is also shown in FIG. 11A and FIG. 11B. The center-to-center spacing S_{C} between conductors 110 is defined by the inner and outer radii a and b of the PCCEs 10. In the example embodiment where PC transparent-conductor assemblies 100 have a single conductor 110 that runs down the center of cloaking element 10, the spacing S_{C}=2b. In the case where conducting element is loosely arranged in interior region 30, then spacing S_{C}˜2b.

With continuing reference to FIG. 13A, the minimum spacing between single conductors 110 each having a radius r_{C} is given by S_{C}=2[r_{C}+(b−a)]. For PCCEs 10 where a=b, the electrode spacing SC=2b and the cloaking element can accommodate a single conductor 110 of radius r_{C}<a. The present invention is suitable for use with conductors 110 that have the same or similar dimensions of such conductor used in optical devices such as displays, e.g., on the order of 100 nm thick and hundreds of nanometers wide.

FIG. 13B is similar to FIG. 13A, but shows an example embodiment wherein conductors 110 arranged as far apart as possible from one another. In this example, the conductor spacing S_{C}=2(a−r_{C}+b). Thus, for a given conductor 110 of radius r_{C}<a, the separation S_{C} of conductors 110 can fall in the range 2[r_{C}+(b−a)]≦S_{C}≦2(a−r_{C}+b). This provides some flexibility for electrode spacing in electrode array 216, particularly in the case where the array consists of two PC transparent-conductor assemblies 100.

It should be noted that the frequency response of PCCE 10, in principle, cannot be perfect. In other words, it can provide cloaking at optical frequencies, but at lower frequencies, say for instance from DC to 10 GHz, the material response of the PCCE could render the cloak inoperable. This would enable the conductor to apply fields and potentials to the material outside the cloak and potentially modifying the optical characteristics of that material. Thus, while optical-wavelength fields will be completely uninfluenced (not dependent upon) of the physical presence of conductors 110, the conductors can still affect the optical fields.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A photonic-crystal (PC) conductor assembly, comprising:
a photonic-crystal cloaking element (PCCE) configured to have a cloaked interior region; and
at least one opaque conductor arranged in the interior region so that the at least one conductor is rendered “transparent” to light of a select wavelength band incident upon the PCCE.

2. The PC transparent-conductor assembly of claim 1, wherein the at least one conductor is formed from at least one metal selected from the group of metals comprising: copper, gold, silver, aluminum, and platinum.

3. The PC transparent-conductor assembly of claim 1, further including at least one light-emitting device electrically connected to the at least one conductor.

4. An array of transparent electrodes comprising two or more of the PC transparent-conductor assemblies of claim 1.

5. The array of transparent electrodes of claim 4, wherein at least two of the two or more PC transparent-conductor assemblies are arranged so that their respective PCCEs are in contact.

6. The PC transparent-conductor assembly of claim 1, wherein the select wavelength band includes one or more visible wavelengths.

7. A PC transparent-conductor assembly, comprising:
a photonic crystal element having an elongate, radially symmetric dielectric annular body with an outer surface having an outer radius b, and an inner surface having inner radius a, and that defines an interior region, the photonic crystal body having a plurality of cylindrical holes formed therein and configured, in combination with the inner and outer radii, to provide the photonic crystal body with a permittivity ε and a permeability μ that satisfies the following cloaking relationships over a select wavelength range:
$${ɛ}_{r} = {μ}_{r} = \frac{r - a}{r} , \\ {ɛ}_{θ} = {μ}_{θ} = \frac{r}{r - a} , \\ {ɛ}_{z} = {μ}_{z} = {( \frac{b}{b - a} )}^{2} \frac{r - a}{r}$$
wherein r is a radial direction, z is an axial direction and θ is an angular direction; and
at least one conducting element being substantially opaque over at least a portion of said wavelength range and arranged in the interior region of the photonic crystal body so that light within said select wavelength range that is incident upon said photonic crystal body at an original trajectory at one portion of the outer surface is redirected in the photonic crystal body and exits the photonic crystal body at another outer surface portion with the original trajectory without passing through the at least one conductor.

8. The assembly of claim 7, wherein the wavelength range includes one or more visible wavelengths.

9. The assembly of claim 7, where the at least one conducting element is a single conducting element in the form of a wire.

10. The assembly of claim 7, wherein the at least one conducting element includes at least one conductor from the group of conductors comprising: copper gold, silver, aluminum, and platinum.

11. An array of transparent conductors, comprising two or more PC transparent-conductor assemblies according to claim 7.

12. The array of transparent conductors according to claim 11, wherein at least one of the two or more PC transparent-conductor assemblies serves as an electrode, and further including at least one light-emitting pixel electrically coupled to the at least one PC transparent-conductor assembly.

13. The array of transparent conductors according to claim 11, wherein at least two of the two or more PC transparent-conductor assemblies are in contact with one another.

14. A method of forming a transparent conductor from an otherwise opaque conductor, comprising:
forming a photonic crystal element to have a refractive index profile that results in a cloaked interior region; and
arranging at least one opaque conductor in the interior region so that the at least one conductor is rendered transparent to light of a select wavelength band incident upon the photonic crystal.

15. The method of claim 14, further including electrically connecting at least one light-emitting device to the least one conductor.

16. The method of claim 14, wherein forming the photonic crystal includes creating an elongate, radially symmetric dielectric annular body with an outer surface having an outer radius b, and an inner surface having an inner radius a and that defines an interior region, including forming in the annular body a plurality of cylindrical holes configured, in combination with the inner and outer radii, to provide the photonic crystal body with a permittivity ε and a permeability μ that satisfies the following relationships over a select wavelength range:
$${ɛ}_{r} = {μ}_{r} = \frac{r - a}{r} , \\ {ɛ}_{θ} = {μ}_{θ} = \frac{r}{r - a} , \\ {ɛ}_{z} = {μ}_{z} = {( \frac{b}{b - a} )}^{2} \frac{r - a}{r}$$
wherein r is a radial direction, z is an axial direction and θ is an angular direction.

17. The method of claim 14, wherein the photonic crystal element and conductor arranged therein constitute a photonic crystal (PC) conductor assembly, and further including:
forming an array of two or more PC transparent-conductor assemblies.

18. The method of claim 17, further including electrically connecting at least one light-emitting device to the at least one of the conductors of the PC transparent-conductor assemblies.

19. The method of claim 14, further including providing the conductor as a metal comprising one or more of: copper gold, silver, aluminum, and platinum.

20. The method of claim 18, further including electrically connecting a plurality of light-emitting device to a corresponding plurality of the conductors of the PC transparent-conductor assemblies so as to form a light-emitting display wherein the conductors are rendered transparent.
